(19) United States
(12) Patent Application Publication
(10) Pub. No.: US 2013/0103933 A1
(43) Pub. Date: Apr. 25, 2013

(54) METHOD OF SHARING FIRMWARE SETTING VALUE

(71) Applicant: Yen-Chao Huang, Taipei City (TW)

(72) Inventor: Yen-Chao Huang, Taipei City (TW)

(73) Assignee: ASUSTEK COMPUTER INC., Taipei City (TW)

(21) Appl. No.: 13/610,879

(22) Filed: Sep. 12, 2012

(30) Foreign Application Priority Data
Oct. 25, 2011 (CN) 201110328498.0

(51) Int. Cl. G06F 15/177

(52) U.S. Cl. 713/1

(57) ABSTRACT

A method of sharing a firmware setting value suitable for an electronic apparatus is provided. The method is executed by an electronic apparatus and includes following steps: logging in to a sharing platform, wherein multiple firmware profiles are stored in the sharing platform and the firmware profiles respectively includes a firmware setting value and a hardware information; searching candidate profiles matching a search criterion in the firmware profiles; displaying the hardware information in the found candidate profiles; downloading a selected one of the candidate profiles according to a selection instruction; and applying the downloaded candidate profile.

### CROSS-REFERENCE TO RELATED APPLICATION

This application claims the priority benefit of China application serial no. 201110328498.0, filed on Oct. 25, 2011. The entirety of the above-mentioned patent application is hereby incorporated by reference herein and made apart of this specification.

### BACKGROUND OF THE INVENTION

1. Field of the Invention

The invention generally relates to an information-sharing mechanism, and more particularly, to a method of sharing a firmware setting value.

2. Description of Related Art

Today, the PC (personal computer) has gradually become an indispensable tool in everyday life. General speaking, in order to enhance the performance of computer systems, the user needs to adjust relevant parameters of peripheral hardware devices according to the demand on the use. In computer system architecture, the basic input output system (hereinafter referred to as BIOS) is the most basic software for the basic operations of the computer system. The BIOS is mainly composed of a series of commands for initializing some most-basic hardware, defining the characteristics of the computer system and processing basic operations for running the computer system, in which the above-mentioned tasks by the BIOS are, for example, to conduct detection or setting on the peripheral hardware equipments of the computer such as hard disk drive, keyboard and connection ports during booting a computer.

After the computer system is turned on but prior to entering the operating system, the user can enter the BIOS setup menu to adjust the relevant parameters of the peripheral hardware devices, that is, to adjust the BIOS setting values. The BIOS setting values include the relevant parameters of the hardware devices such as motherboards and interface cards (for example, working voltage and working frequency of the CPU). By adjusting each setting value by the user, the computer system can achieve its best performance.

### SUMMARY OF THE INVENTION

The disclosure is directed to a method of sharing a firmware setting value suitable for an electronic apparatus. In the method, following steps are performed by the electronic apparatus: logging in to a sharing platform, in which the firmware profiles are stored in the sharing platform and the firmware profiles respectively includes a firmware setting value and a hardware information; searching a plurality of candidate profiles in the firmware profiles according to a search criterion, that is to say the firmware profiles include the candidate profiles therein; displaying the hardware information in the found candidate profiles; downloading a selected one of the candidate profiles according to a selection instruction; and applying the downloaded candidate profiles.

In an embodiment of the present disclosure, the above-mentioned method of sharing the firmware setting value further includes displaying the firmware setting value and the hardware information in the selected candidate profile according to the selection instruction.

In an embodiment of the present disclosure, the above-mentioned method of sharing the firmware setting value further includes uploading each of the firmware profiles of the electronic apparatus to the sharing platform.

In an embodiment of the present disclosure, the above-mentioned step of uploading each of the firmware profiles of the electronic apparatus to the sharing platform includes: loading an operation system by the electronic apparatus; capturing the firmware setting value of the electronic apparatus under the present executive state and capturing the hardware information of the electronic apparatus under the present executive state; storing the captured firmware setting value and hardware information as one of the firmware profiles; and uploading the said firmware profile to the sharing platform.

In an embodiment of the present disclosure, in the above-mentioned method of sharing the firmware setting value, the operation further includes: during uploading one of the firmware profiles to the sharing platform, encrypting the said firmware profile and after downloading the selected candidate profile, decrypting the downloaded candidate profile.

In an embodiment of the present disclosure, the above-mentioned method of sharing the firmware setting value further includes: providing a user interface for performing the method of sharing the firmware setting value through the user interface.

In an embodiment of the present disclosure, the above-mentioned method of sharing the firmware setting value further includes: logging in to the sharing platform through a browser; searching the candidate profiles matching a search criterion through the browser; after downloading the selected candidate profile, applying the downloaded candidate profile through the user interface; and starting an assessment page through the browser so as for the user to rate the firmware profiles stored by the sharing platform in the assessment page. In this way, as the candidate profiles matching the search criterion are found out, the method can sort the candidate profiles according to the rating scores of the firmware profiles.

In an embodiment of the present disclosure, the above-mentioned hardware information includes a motherboard model, a firmware version number, a processor model, memory capacity, a graphic car model or a cooling configuration. The above-mentioned the firmware setting value is a voltage value of a hardware or a base clock (BLCK) of a processor. The above-mentioned search condition includes the motherboard model, the firmware version number or the processor model.

Based on the description above, the disclosure can allow different users to apply the ready firmware setting value obtained after the adjusting and verification by other people and further allow other users to search and preview in advance according to the hardware and the cooling configurations of the electronic apparatuses used by the other users. As a result, the users can be aware of whether or not the found out firmware profiles meet the requirements thereof and can decide whether or not to apply the settings to the own cases, which enables different users for working in cooperation way through the sharing platform.

The description above is an overview of the scheme of the present disclosure only. In order to make the aforementioned and other features and advantages of the disclosure more comprehensible, embodiments accompanying figures are described in detail below.

### BRIEF DESCRIPTION OF THE DRAWINGS

FIG. 1 is a schematic diagram of a system of sharing a firmware setting value according to an embodiment of the disclosure.

FIG. 2 is a flowchart of a method of sharing a firmware setting value according to an embodiment of the disclosure.

FIGS. 3A and 3B are schematic diagrams of a user interface according to an embodiment of the disclosure.

FIG. 4 is a schematic diagram of an assessment page according to an embodiment of the disclosure.

FIG. 5 is a flowchart showing the method of uploading a firmware profiles to the sharing platform according to an embodiment of the disclosure.

### DESCRIPTION OF THE EMBODIMENTS

The following drawings and preferred embodiments are intended to explain the method of sharing a firmware setting value and the feature and effect thereof provided by the disclosure, which are described in detail as follows.

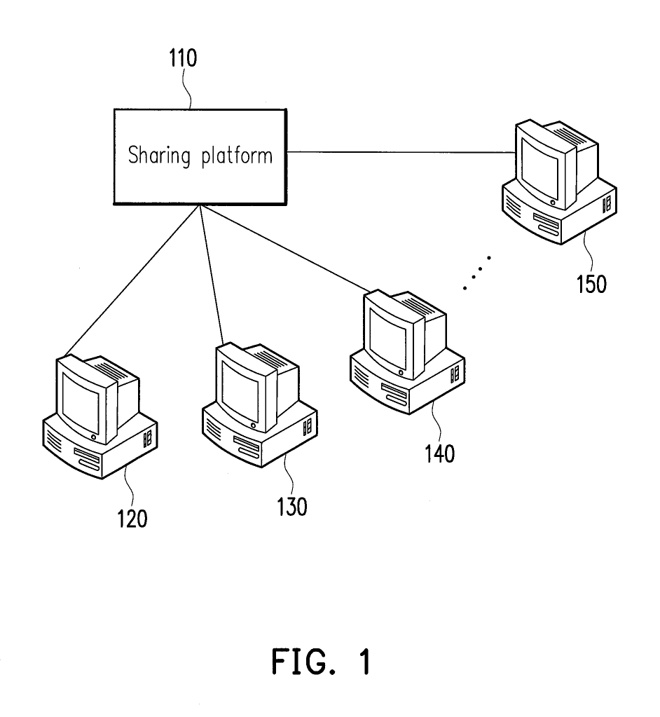

FIG. 1 is a schematic diagram of a system of sharing a firmware setting value according to an embodiment of the disclosure. Referring to FIG. 1, a sharing platform 110 is, for example, a cloud server provided to a plurality of electronic apparatuses (as shown in FIG. 1, 120, 130, 140 and 150) for sharing the firmware setting value thereof. The electronic apparatuses 120, 130, 140 and 150 are, for example, personal computers (PCs), and respectively have a central processing unit (CPU), a control chip set (for example, south-bridge chip set and north-bridge chip set), a memory and a firmware. The electronic apparatuses 120, 130, 140 and 150 are respectively used by different users, who can upload at least one firmware profile thereof to the sharing platform 110 through the electronic apparatuses 120, 130, 140 and 150, or can download an appropriate profile from the sharing platform 110. In terms of the current technique, the firmware in a PC is a basic input/output system (BIOS). BIOS is usually stored in a read only memory (ROM), the BIOS setting values are stored in a non-volatile random-access memory (NVRAM) and include parameters related to the hardware devices such as a motherboard and interface cards (for example, the parameters include a working voltage and a working frequency of the CPU and so on).

The sharing platform 110 stores a plurality of firmware profiles. The firmware profiles respectively include a firmware setting value and a hardware information. For example, the hardware information includes a motherboard model, a firmware version number, a processor model, a memory capacity, a graphic card model and a cooling configuration, in which the cooling configuration is, for example, a cooler type such as an air cooler, a water cooler and so on. The firmware setting value is one of voltage values of multiple hardware (CPU, memory, control chips and so on) and a base clock (BLCK) of the processor in the electronic apparatus.

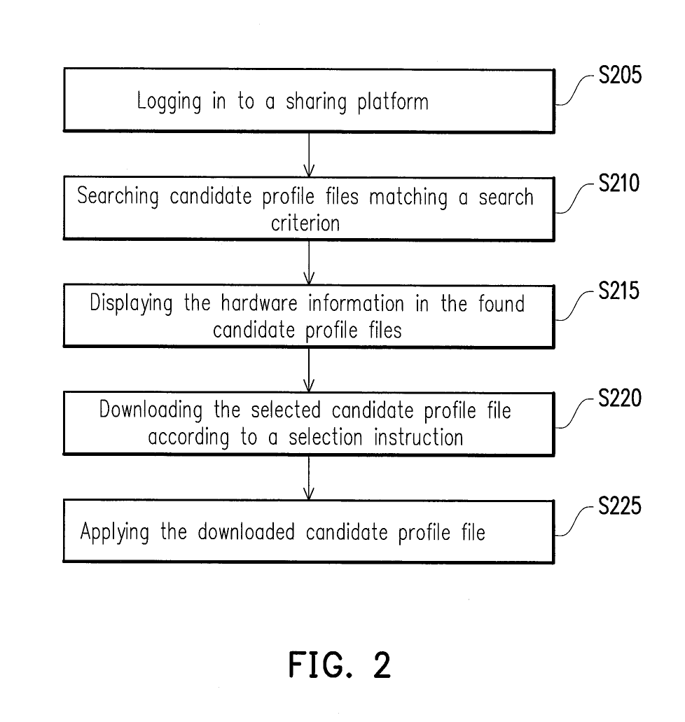

The operations between each of the electronic apparatuses 120, 130, 140 and 150 and the sharing platform 110 are roughly the same as each other. For depiction convenience, only the electronic apparatus 120 is taken as an example for describing all the steps of sharing the firmware setting value. FIG. 2 is a flowchart of a method of sharing the firmware setting value according to an embodiment of the disclosure. Referring FIGS. 1 and 2, in step S205, the user logs in to the sharing platform 110 through the electronic apparatus 120. For example, an application is installed in the electronic apparatus 120 and the electronic apparatus 120 is connected to a network through the application so as to log in to the sharing platform 110. The application is compiled by using a program language and the application is installed in the electronic apparatus 120 so as to execute all the steps of sharing the firmware setting value through the application

In step S210, the user searches a plurality of candidate profiles in the firmware profiles of the sharing platform 110 according to a search criterion, in which the firmware profiles include the above-mentioned candidate firmware profiles. That is to say, the candidate profiles are obtained by screening the firmware profiles. For example, the application provides a user interface so that the user can select or input the search criterion through the user interface. The search criterion includes at least one of the motherboard model, the firmware version number and the processor model. For example, the user selects (or inputs) the motherboard model “Maximus IV Extreme” as the search criterion and then presses down the search button so as to search the firmware profiles containing the motherboard model “Maximus IV Extreme” in the firmware profiles stored in the sharing platform 110 as the candidate profiles.

Then in step S215, the hardware information in the found candidate profiles are displayed. For example, the hardware information in the found candidate profiles is displayed in the user interface for the user to browse. In this way, the user is able to select a desired one of the candidate profiles for use according to the hardware information and further to decide whether or not downloading according to the rating score of each the candidate profile.

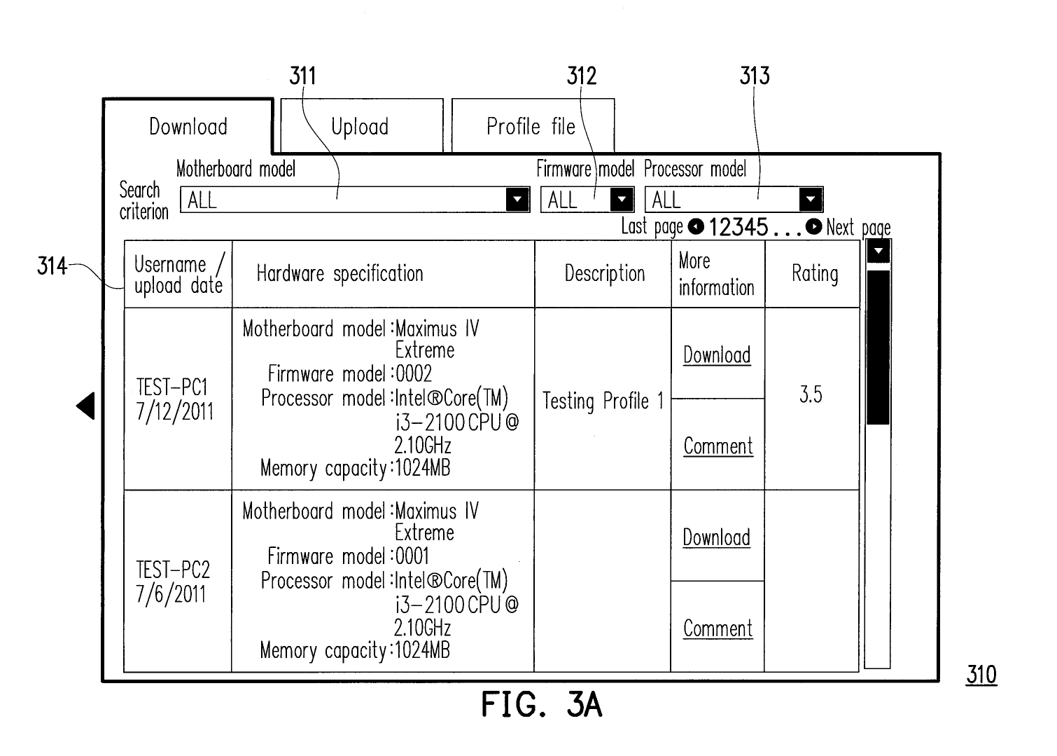

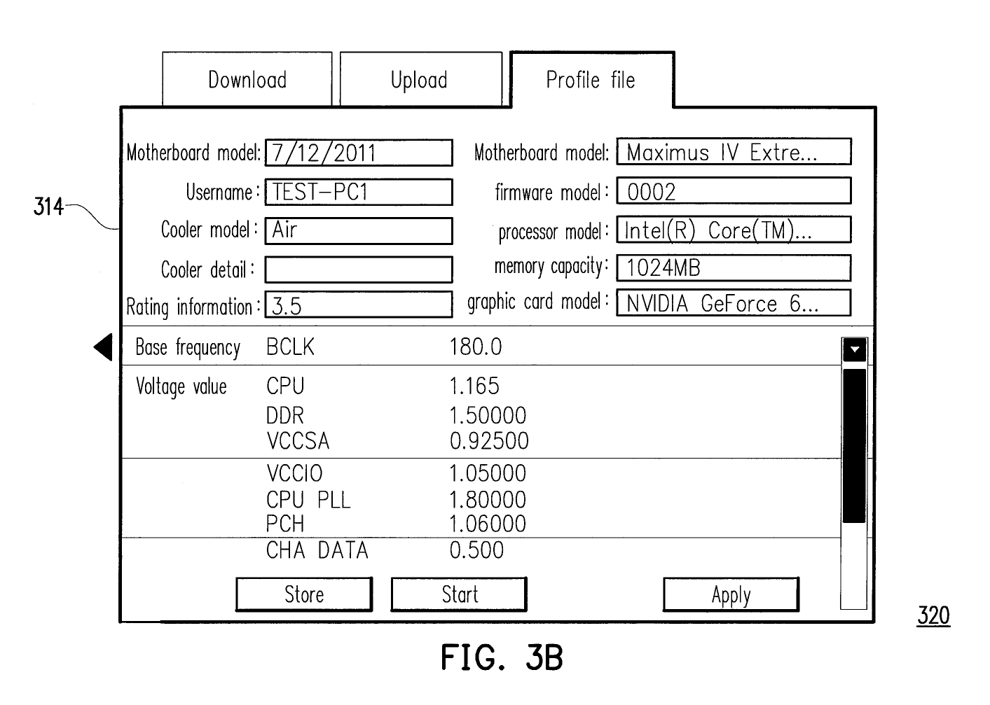

FIGS. 3A and 3B are, as an example, schematic diagrams of a user interface according to an embodiment of the disclosure. FIG. 3A shows a download page 310 in the user interface and FIG. 3B shows a firmware profile page 320 in the user interface.

Referring to FIG. 3A, the download page 310 includes a plurality of search criterions selectable by the user, and the search criterions include a motherboard model 311, a firmware version number 312 and a processor model 313. In the embodiment, it is not to restrict anyone of the search criterions, it can be listed all firmware profiles in the download page 310 as the candidate profiles. After searching, the found candidate profiles would be displayed in a form 314 in the download page 310. At the time, each row of the form 314 represents a candidate profile, and the form 314 includes five fields for respectively displaying username/upload date, hardware specification, description, more information and rating.

The field of username/upload date herein is for displaying the username who uploads the candidate profile to the sharing platform 110 and the upload date of the candidate profile. The field of hardware specification is for displaying the hardware specification in the candidate profile including the motherboard model, the firmware version number, the processor model and the memory capacity. The field of description is for displaying other notes of the firmware profile; for example, if other notes are attached during uploading the firmware profile, the other notes would be displayed at the time in the field of description of the download page 310. The field of more information is for displaying a download option and a comment option, in which the download option is for downloading the firmware profile and the comment option is linked to an assessment page for filling out a comment and rating. The field of rating is for displaying the rating scores of the firmware profile. If the candidate profile has not been rated before, the field of rating remains blank.

After the user selects one of the candidate profiles (for example, by highlighting to select), the user can click the profile page to view the detail content. Referring to FIG. 3B, in addition to displaying the hardware specification, in the firmware profile page 320, the firmware setting value is further listed. The hardware specification herein further includes cooler type and cooler detail which can be filled out by the user self or obtained by automatic detection of the electronic apparatus 120. In the firmware profile page 320, the upload date of the candidate profile, the username who uploads the candidate profile and the rating information are also listed.

The firmware setting value in the embodiment includes base frequency of processor and voltage values of other hardware. These voltage values are, for example, the voltage value of the CPU, the voltage value of the memory (the memory is double data rate synchronous dynamic random access memory, i.e., DDR SDRAM), VCCIO voltage value of the CPU, VCCSA voltage value and PLL voltage value of the CPU, voltage value of the south-bridge chip (the south-bridge chip herein is a platform controller hub chip, i.e., PCH chip) and CHA SATA voltage value. With the firmware setting value, if a user wants to run in over-frequency way, the user can make decision according to the listed voltage values for selecting the candidate profile to run in over-frequency way.

It should be noted that the electronic apparatus 120 can directly log in to the sharing platform 110 through the browser and then search the candidate profiles matching the search criterion through the browser. After downloading the selected one of the candidate profiles, the user can apply the downloaded candidate profile through the user interface. In addition, the user can start an assessment page through the browser for the user to rate or fill out the comment in the assessment page on the firmware profiles stored in the sharing platform 110. As a result, the electronic apparatus 120 can sort the candidate profiles according to the above-mentioned rating scores as finding out the candidate profiles matching the search criterion.

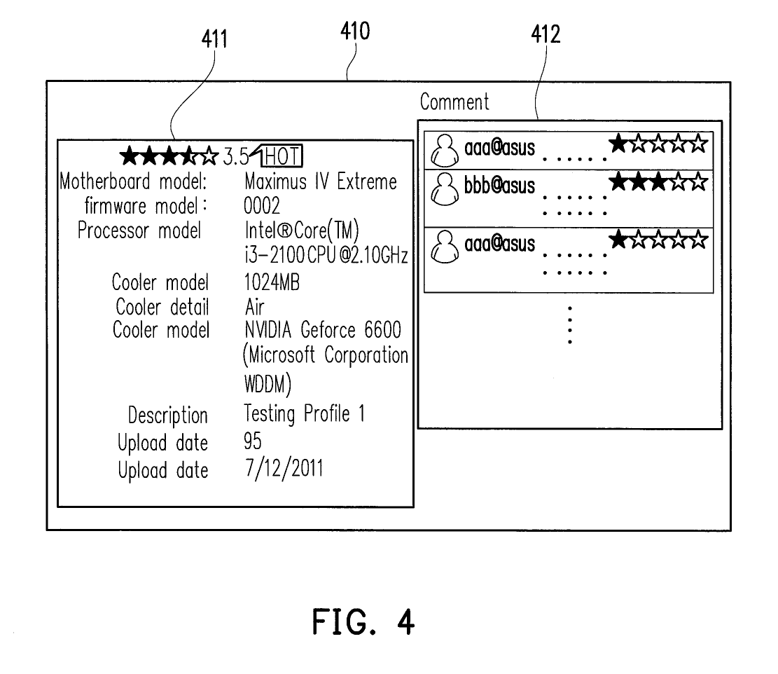

FIG. 4 is a schematic diagram of an assessment page according to an embodiment of the disclosure. Referring to FIGS. 3A and 4, after finding out the candidate profiles matching the search criterion and displaying the candidate profiles in the download page 310, if the user clicks a comment option of candidate profile “TEST-PC1”, the electronic apparatus 120 would start the browser to be linked to the assessment page 410 as shown by FIG. 4. The assessment page 410 contains a field of profile content 411 and a field of comment 412. In the field of profile content 411, an average rating score of the candidate profile and other hardware information are listed. At the time, the user can browse the ratings and comments of other users on the candidate profile in the field of comment 412 located at the upper-right corner, and the user can give rating and comment on the candidate profile in the field of comment 412.

In other embodiments, the assessment page 410 can further contain buttons of social networking site such as Facebook's “like” button or Google+'s “+” button so as to identify firmware profiles through the social networking sites.

Back to FIG. 2, after the user has selected one of the candidate profiles, in step S220, the electronic apparatus 120 downloads the selected candidate profile according to a selection instruction (for example, enabling a download option to send out the selection instruction). At the time, when the user selects one of the candidate profiles, in addition to displaying the hardware information in the selected candidate profile in the user interface, the firmware setting value in the selected candidate profile can be displayed for the user to browse. After downloading the candidate profile, step S225 is performed to apply the downloaded candidate profile.

It should be noted that in the method of sharing firmware profiles, the electronic apparatus 120 can download the firmware profile from the sharing platform 110, and further upload the firmware profile to the sharing platform 110 as well. In following, yet another embodiment is depicted to explain the steps for uploading the firmware profile of the electronic apparatus 120 to the sharing platform 110.

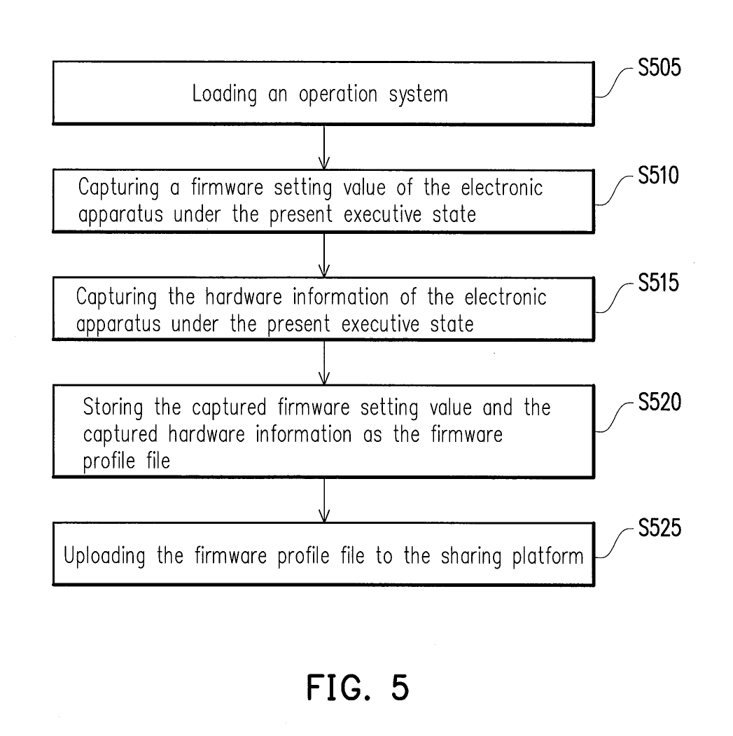

FIG. 5 is a flowchart showing the method of uploading a firmware profiles to the sharing platform according to an embodiment of the disclosure. Referring to FIGS. 1 and 5, in step S505, the electronic apparatus 120 loads an operation system (OS). After the electronic apparatus 120 is booted, step S510 is performed, where the firmware setting value of the electronic apparatus 120 under the present executive state is captured and step S515 is performed, where the hardware information of the electronic apparatus 120 under the present executive state is captured. The scheme of capturing the firmware setting value and the hardware information only after the electronic apparatus 120 is booted can avoid malicious settings during the BIOS implementation phase (for example, malicious setting of an ultra-high voltage value or an ultra-high base frequency) so as to prevent spreading the malicious setting to others for use.

Thereafter in step S520, the captured firmware setting value and the hardware information are stored as a firmware profile. Then in step S525, the firmware profile is uploaded to the sharing platform 110. For example, steps S510-S525 are performed by using the above-mentioned application, while the user interface provided by the application contains an upload page. The displayed content of the upload page is, for example, similar to FIG. 3B, which is omitted to describe. The upload page also contains the captured hardware information and firmware setting value therein. In the upload page, the user can revise the cooler type, the cooler detail, the username or the upload date.

In addition, when uploading the firmware profile to the sharing platform 110, the user can encrypt the firmware profile through the application, and after downloading the selected candidate profile, the user can decrypt the selected candidate profile through the application again. In fact, for example, the application includes an encryption key, which is configured for conducting encryption and decryption operations on the uploaded/downloaded firmware profile after installing the application in the electronic apparatus 120,

In summary, based on the above-mentioned embodiments, the disclosure allows different users to upload the firmware setting value of their own to the sharing platform and download the firmware setting value of other users. By using the above-mentioned sharing mechanism, different users can rate the uploaded firmware profiles so as to serve as the reference ground for deciding download or not. In addition, for the firmware with different versions, the corresponding firmware profiles are unable for sharing, the above-mentioned method of the disclosure can provide the users with the displayed hardware specifications of the found candidate profiles for the users to browse and thereby to decide downloading or not by using the method. Moreover, the electronic apparatus captures the hardware specification and the firmware setting value only after the electronic apparatus is booted, which can avoid the malicious setting values during running BIOS are spread to other people for troubles.

It will be apparent to those skilled in the art that the descriptions above are several preferred embodiments of the disclosure only, which does not limit the implementing range of the disclosure. Various modifications and variations can be made to the structure of the disclosure without departing from the scope or spirit of the disclosure. The claim scope of the disclosure is defined by the claims hereinafter.

What is claimed is:

1. A method of sharing a firmware setting value, suitable for an electronic apparatus and comprising:
logging in to a sharing platform, wherein a plurality of firmware profiles are stored in the sharing platform and each of the firmware profiles comprises a firmware setting value and hardware information;
searching a plurality of candidate profiles in the firmware profiles according to a search criterion;
displaying the hardware information in each of the candidate profiles;
downloading a selected one of the candidate profiles according to a selection instruction; and
applying the downloaded candidate profile to the electronic apparatus.

2. The method of sharing the firmware setting value as claimed in claim 1, wherein before the step of downloading the selected one of the candidate profiles according to the selection instruction, the method further comprises:
displaying the firmware setting value and the hardware information in the selected candidate profile for confirmation and then inputting the selection instruction.

3. The method of sharing the firmware setting value as claimed in claim 1, wherein each of the firmware profiles is uploaded to the sharing platform by the electronic apparatus.

4. The method of sharing the firmware setting value as claimed in claim 3, wherein the step of uploading each of the firmware profiles to the sharing platform by the electronic apparatus comprises:
loading an operation system;
capturing the firmware setting value of the electronic apparatus under present executive state;
capturing the hardware information of the electronic apparatus under the present executive state;
storing the captured firmware setting value and the captured hardware information as one of the firmware profiles; and
uploading the firmware profile to the sharing platform.

5. The method of sharing the firmware setting value as claimed in claim 3, wherein the step of uploading each of the firmware profiles to the sharing platform by the electronic apparatus further comprises:
during uploading each of the firmware profiles to the sharing platform, encrypting each of the firmware profiles.

6. The method of sharing the firmware setting value as claimed in claim 1, wherein before the step of applying the downloaded candidate profile to the electronic apparatus, the method further comprises:
decrypting the downloaded candidate profile.

7. The method of sharing the firmware setting value as claimed in claim 1, wherein before the step of searching the candidate profiles in the firmware profiles according to the search criterion, the method further comprises:
providing a user interface for inputting the search criterion.

8. The method of sharing the firmware setting value as claimed in claim 7, further comprising:
after inputting the search criterion through the user interface, searching the candidate profiles matching the search criterion through a browser; and
after downloading the selected candidate profile, applying the downloaded candidate profile to the electronic apparatus through the user interface.

9. The method of sharing the firmware setting value as claimed in claim 8, further comprising:
starting an assessment page through the browser so as to rate the firmware profile stored by the sharing platform.

10. The method of sharing the firmware setting value as claimed in claim 9, wherein after the step of searching the candidate profiles in the firmware profiles according to the search criterion, the method further comprises:
sorting the candidate profiles according to rating scores of the firmware profiles.

11. The method of sharing the firmware setting value as claimed in claim 1, wherein the hardware information comprises at least one of a motherboard model, a firmware version number, a processor model, a memory capacity, a graphic car model and a cooling configuration; the firmware setting value is a voltage value of a hardware or a base clock (BLCK) of a processor; the search condition comprises one of the motherboard model, the firmware version number and the processor model.
